(19) United States
(12) Patent Application Publication
(10) Pub. No.: US 2013/0050401 A1
(43) Pub. Date: Feb. 28, 2013

(54) PORTABLE WIDE-ANGLE VIDEO RECORDING SYSTEM

(71) Applicants: Gunter Tannhaeuser, Nuernberg (DE); Pouyan Anvarj, Herbrechtingen (DE)

(72) Inventors: Gunter Tannhaeuser, Nuernberg (DE); Pouyan Anvarj, Herbrechtingen (DE)

(73) Assignee: Breitblick GmbH, Ellwangen (DE)

(21) Appl. No.: 13/394,318

(22) PCT Filed: Sep. 4, 2009
(86) PCT No.: PCT/IB2009/006781

§ 371 Date: Jul. 10, 2012

(51) Int. Cl. H04N 7/00

(52) U.S. Cl. 348/36; 348/E07.001

(57) ABSTRACT

A portable video recording system is disclosed, comprising an array of camera modules. The set is equipped with gyroscopes, to allow the extrapolation of the camera's movement from a stitched wide-angle reproduction.

From a composed series of master images, picture format and focus can be selected in post production, which avoids sighting and manual settings during recording.

### FIELD OF THE INVENTION

The invention relates to a video recording, -transmitting and -reproduction system with a set of camera modules, gyroscopes and recording or transmittal units.

The associated procedure comprehends the selection of format and focus of a resulting video from a directional stabilized series of master images, which are formed in post-processing by deskewing, aligning and stitching a series of single images from the camera modules.

### BACKGROUND OF THE INVENTION

Mobile video recording usually in done with a video camera, that is held in front of the camera-man, who is controlling the scene looking through a viewfinder or screen.

There are fundamental disadvantages in this system:

Firstly the cameraman, if alone, is necessarily overcharged with simultaneously reviewing the general scene and watching the picture on the viewfinder or screen, while selecting picture detail, zooming and focussing (in particular correcting improper automatic focussing) and camera settings.

Within a film team, these jobs are shared among director, cameraman and technical staff. However, at live recordings on an unprepared scenery, even experienced teams always work at the edge of their capability.

This is clearly to be seen at less spatial stability of live reports, in particular if recordings have to be made on the move, where existing de-shaking methods fail.

Amateurs and single reporters without team even face greater problems with these simultaneous charges. Therefore results are often quite poor in comparison to professional recordings, even though the technical standards of the equipment are not more far apart.

Another serious drawback of conventional camera usage is visible sighting: individuals as objects use to react in different ways as soon as they realize that they are recorded, whether that is “cheese . . . cake . . . ing” and beckoning or gurning, freezing mien, reacting aggressively or turning away, but often are unlikely to continue their normal action, that is meant to be recorded.

Another major problem, particularly for amateurs and single reporters is that the necessity of holding the camera manually handicaps in many ways: whether there is a need to get hold for oneself, or if other objects have to be handled simultaneously, or e.g. small children cannot understand why dad or mom hold that awkward case between them.

### PROBLEM TO BE SOLVED

Therefore it is the object of the here disclosed invention, to find a method of video recording that would avoid holding the camera manually and visibly sighting objects, as well as to avoid or facilitate focussing and settings when recording.

### BASIC DESCRIPTION OF THE INVENTION

The proposition is to wear the camera system like a bodycam that records the full visible range, but to use a plurality of identical camera modules as used in mobile phones, but with more focal length, vertical format alignment and preferably set in a constant horizontal angle to each other, so to acquire an image resolution that allows good zooming and reframing in post-production. On a PC the series of single recordings are stitched together to form a master image set, that is realigned as to recorded motion sensor's signals before selection of a desired display window.

### PRIOR ART

Bodycams, as disclosed in GB 2 456 587 A, are well known in the art, usually attached to uniform flaps or mounted in helmets. They use to contain a wide-angle or even fisheye lens system and are usually applied for documentation or even for remote leading of missions.

The disadvantage of these systems is, that extreme wide angle lens systems show heavy distortions. These can electronically be corrected to some degree (as e.g. disclosed in U.S. Pat. No. 7,277,118 B2), but that again leads to some itemization, that would prevent to achieve a high video resolution.

Moreover, the wide angle covered by one lens provides a strongly reduced ratio of magnification for distant objects, whereas close objects are overscaled.

This might give an impressive view, but masks distant objects and reduces the chance to recover their details.

Other bodycam systems, comprising a plurality of cameras, as in US 2009109292(A1), are meant to provide alternative views, but not stitched or composed images.

Other systems might incorporate multi-camera applications, but usually are not portable, and mostly refer to cameras surrounding objects, as in WO 99/35850, particularly if installed for acquiring 3D-Vision, as in WO 02/096096 A1, CN 101 321302A, WO 2007/048197 A1, or at least for better contrasting foreground and background content, as in U.S. Pat. No. 7,420,590 B2, if not for registration of other 3-dimensional content, as in a rotating installation in U.S. Pat. No. 7,542,073 B2.

Furthermore some propositions cover panoramic views with a set of cameras, as in U.S. Pat. No. 7,298,392 B2, and quite a few former film camera sets, which all are not intended and not applicable for portable recording, but, if needed, are run on carriages along railway tracks.

Other multi-camera installations with a set of horizontal and vertically arranged camera modules also refer to panning and zooming in a post-processing stage as in U.S. Pat. No. 7,015,954, but stitching horizontally and vertically adjacent images require elaborate techniques for dewarping and realigning each single frame, as described in U.S. Pat. No. 7,277,118 B2. To achieve perfect results, it is furthermore mostly necessary to manually retouch critical transitions, what makes it laborious and thus hardly operable except for still photography. Therefore they are not indicated for mobile application or particularly body wear and do not contain motion compensation.

There are, moreover, multi-camera systems known to be used for enhancing resolution like for for X-ray-systems, as in U.S. Pat. No. 6,002,743 and U.S. Pat. No. 6,921,200 B1, but that need to be kept in a fixed position and therefore do not relate to mobile video.

With alternative techniques for mobile video, as using sophisticated wide-angle lens systems and elaborate image sensor techniques, the limits are given with the resolving capacity of even the best objectives and the limits of pixel resolution and color or luminance noise of single image sensors.

This is overcome in the here disclosed proposition by multiplying the camera modules and electronic stitching the resulting image contents.

### DESCRIPTION OF A SIMPLE EMBODIMENT

In a basic embodiment for a personal view (150°) video the camera set comprises six units, each at least covering a 25° horizontal angle, whereas, for better stitching at least 5° and particularly if contour recognition techniques are applied for it, an overlapping field angle of another half image size could be added at both overlapping sides.

These angles of view (30° up to) 50° relate to rather tele-type objectives, comparable to 75 to 90 mm focal length on 35 mm cameras (having 24×36 mm image size), which usually show rather little distortion.

Since these units should be as small and lightweight as possible and work with a minimum of power consumption, the image data of the single camera units are most easily fed without compression (raw format) via standard processors or preferably a hierarchy of configurable interconnects (e.g. field-programmable gate arrays—FPGA) into a set of flash memory chips, which are selected due to speed and storage volume.

If e.g. one of six camera chips deliver 1.2 MP each, from which 0.5 MP is to be recorded with full resolution at 10 bit color depth and 25 frames per second, a data flow of about 15 MB/s should result at common 5/4 format, together with camera module settings, approximately 10 kB/s of data from gyros and HiFi stereo sound system of 260 b/s a total of less than 16 MB/s must be transferred to the storage unit. This is well feasible with a standard performance FPGA.

The images later can be transferred at 60 MBIs via a USBII connector, or better by standard IEEE1394 (FireWire®) transfer at up to 3 Gibit/s to the processing computer, wherein commercial programs would be apt to stitching the overview image with all necessary corrections based on the co-transferred data and process the resulting video master images as to settings for format, display window and the use of particular video enhancing techniques.

In another embodiment for panoramic registration, six or more cameras are applied to cover a full surround view.

The camera modules are preferably identical and set on fixed focus and constant aperture (since light sensitivity today can quite well be automatically adjusted on CMOS image sensors), as well as arranged in a constant horizontal angle to each other, so to avoid different depth of focus and the necessity of elaborate dewarping and manual retouching their images before stitching.

The camera set can be arranged in a helmet or headband or carried in a small case on a necklace or bolo tie type laces and a tie clip on the chest or rear upper body of the cameraman but the system might as well fit into a ticket pocket, leaving the camera strip poke out on top.

The system is further equipped with a gyroscope of three axis acceleration sensors and linear acceleration sensors to co-register data on exact spatial position and movement of the camera set. Appropriate units, using miniature MEMS inertial sensors are well available on the market.

These units are applied for stabilizing horizon and azimuth of view in post-processing a master image, while twisting images or cutting off picture margins vertically and horizontally as far as the inner frame of view is not entangled.

Stitching the images in post processing can easily be done with small overlapping zones by aligning the margins of the images, as long as optical distortion rests marginal (as is with mild telephoto lenses) or is already compensated electronically in the image sensor system, as commonly provided today. This is usually effectuated by proofreading lens distortions, as e.g. described in CN 101064780 (A).

The signals of the camera modules are recorded, preferably on flash register units and transferred later, or immediately transmitted by cable or wireless communication to a basis station, where the images are processed together with alongside communicated signals for the settings of the image sensor electronics (sensitivity, white balance, etc.), as well as sound recording and position and acceleration data.

### DESCRIPTION OF A PREFERRED EMBODIMENT

In a preferred embodiment, the signals from each camera unit are compressed in real time, e.g. with H.264 codec, which is well established in the art, and today feasible using standard integrated circuitry with low power consumption. This allows the application of high resolution image sensors at acceptable transfer rates for wireless transmission, as well as moderate data storing capacity.

Since compression rates of up to 50:1 are almost undiscernible to the viewer, but compression artefacts should be kept minor to the gain of the quality of resulting data, we found that a compression rate of 30:1 would result in a superior overall image with the above mentioned set. However, whereas required memory for storage would be unchanged, power consumption of a single processor must be allowed for 500 mW, thus 3 Watts for our sample of 6 cameras would require a battery capacity of another 1 W/h, which means that at 1.2 Volt operation another 1 Ah battery and thus a minimum of 40 grams more are to be carried for a 30 minutes runtime—which still seems quite acceptable.

Further processing comprises the aforementioned correction of single image distortions and stitching a master frame sequence of the coeval images from the different camera modules.

Here a more elaborate concept for exact realigning images for stitching can be used with the application of image analysis and contour recognition methods in post-processing, which, for acceleration of this process, will be applied in combination with above mentioned conventional pre-aligning.

Furthermore a realignment of the master image positions will be executed as to the correction signals derived from the gyro and acceleration sensors, so to achieve a stable master image on screen.

Software for stitching images is on the market in a multitude of versions (as e.g. subsumed in CN 101146231 (A)) and the technique of correcting camera shake is well known in the art—whereas hitherto used for correction along with recording and not with recorded movement data in post-processing.

However, in an advanced embodiment it is as well possible to apply conventional de-shaking systems and combine it with post-processing image stabilization using recorded gyro data, since the latter is primarily meant for stabilizing the image on a larger scale, so not to confuse the observer with the body movement of the cameraman. The combination of both techniques might be particularly advantageous if fast online de-shaking is provided by lens or target shifting, thus avoiding the smearing effect of camera shake at low exposure time. It only requires an additional recording and later extrapolation of the shifting data from the image stabilization in post-processing.

By means of available picture editing software it is finally possible to select a picture format and to cut out the desired picture content from the master images for further recording and processing.

### BRIEF DESCRIPTION OF THE DRAWINGS

FIG. 1 describes the general workflow from single camera images unto the final cutout.

FIG. 2, FIGS. 3 and 4 demonstrate possible applications with very small camera modules, carried as headband, on a necklace and in a ticket pocket.

FIG. 5 shows the construction of a a camera set, consisting of 6 camera units.

### DETAILED DESCRIPTION OF THE DRAWINGS

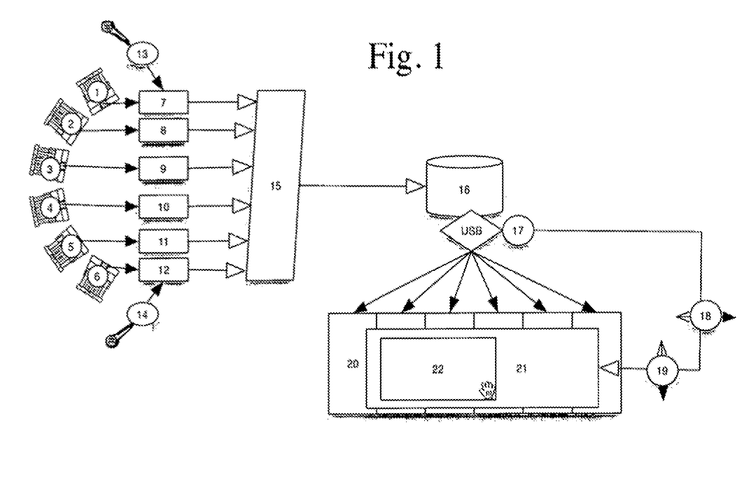

FIG. 1 shows an array of six camera-Units 1-6 and two microphones 13 and 14, transmitting their signals to the compression units 7-12, which deliver their outputs to an FPGA 15, which is sorting it by interconnecting signals to feed it into the flash storage unit 16 (which might consist of several flash modules—not shown here).

The readout is done via a USBII connection to the post processing system 23, where these signals are stitched into one suite of general images 20. The output 17 contains the signals of the motion detection in horizontal 18 and vertical direction 19 and roll or twist (not indicated), by which the master images 21 are selected from the general images 20. The movable frame 22 demonstrates the possibility to select format and particular view from the master images 21 with conventional video editing software.

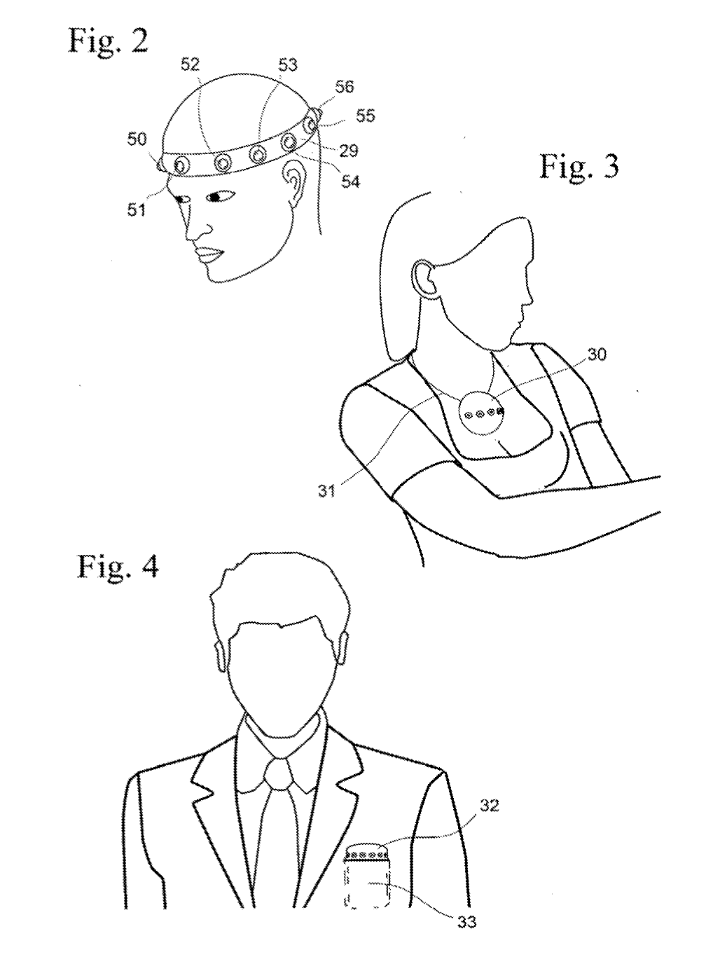

FIG. 2 shows a set of cameras for surround recording wherein the modules 50 to 57 are visible and another five on back side, carried in a headband 29.

FIG. 3 demonstrates wearing the camera set 30 on a necklace 31.

FIG. 4 shows another camera set 32 in a ticket pocket 33.

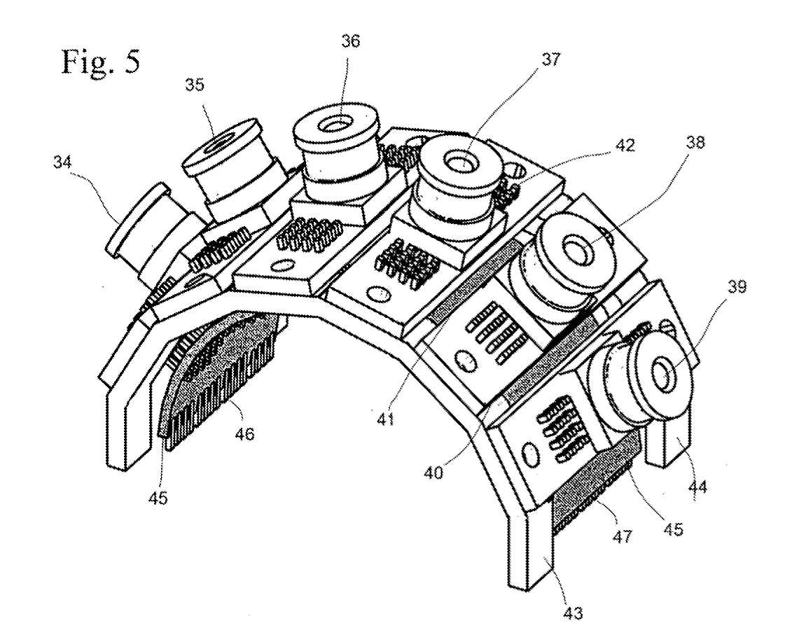

FIG. 5 discloses a possible assembly of 6 camera modules 34-39, each one mounted to a printed board 40 (exemplarily) containing several layers and electronic parts (not visible), as well as connecting pins 41, 42.

These printed boards may be mounted to holding bridges 43 and 44, whereas the connecting pins 41, 42 lead to a flexible interconnect 45, which might as well carry some electronics (not shown) and ends in another set of interconnecting pins 46 and 47, that may be plugged into a mother board (not shown).

What is claimed is:

1. A portable wide-angle video recording and processing system with an array of identical camera modules, wherein the serial images of these camera modules are radio-transmitted or recorded and processed together with the output of attached gyro sensors, to be electronically stitched together with extrapolating the camera array's movement.

2. A portable wide angle video recording and processing system as set forth in claim 1, wherein the camera system is only used for recording or wireless transmission, whereas the processing of the images is effected in a computer system outside of the camera set.

3. A portable wide angle video recording and processing system as set forth in claim 1, wherein image contents of the camera modules are sequentially transferred to and stored within a Hash memory set.

4. A portable wide angle video recording and processing system as set forth in claim 3, wherein the sequential transfer is provided by field-programmable gate arrays (FPGAs).

5. A portable video recording and processing system as set forth in claim 2, wherein wireless transmission is executed via UHF communication.

6. A portable wide angle video recording and processing system as set forth in claim 1, wherein the movement of the camera set is recorded or transferred from integrated 3-axial gyro sensors.

7. A portable video recording and processing system as set forth in claim 6, wherein these gyro sensors are of the MEMS inertial sensor type.

8. A portable video recording and processing system as as set forth in claim 1, wherein all camera modules contain single anti-shake devices.

9. A portable video recording and processing system as set forth in claim 8, wherein anti-shake is executed by correcting lens movements.

10. A portable video recording and processing system as set forth in claim 8, wherein anti-shake is executed by correcting the image sensor's position.

11. A portable video recording and processing system as set forth in claim 1, wherein tracking data of single anti-shake devices are registered and processed alongside the single video streams, for later to be processed together with the gyro-data of the camera array.

12. A portable video recording and processing system as set forth in claim 1, wherein the output of all camera modules are compressed before transmitting or recording.

13. A portable video recording and processing system as as set forth in claim 12, wherein video compression is executed using H.264 codec.

14. A portable wide angle video recording and processing system as set forth in claim 1, wherein the horizontal angle of photography covers a surround view.

15. A portable wide angle video recording and processing system as set forth in claim 1, wherein the entire angle of imaging overlap the major human field of view, thus at least 150°×80°.

16. A portable wide angle video recording and processing system as set forth in claim 1, wherein the images of adjacent camera modules overlap partially.

17. A portable wide angle video recording and processing system as set forth in claim 16, wherein the overlapping data is, besides better stitching, also used for electronic correction of chromatic noise and smearing.

18. A portable wide angle video recording and processing system as set forth in claim 1, wherein the images of the single camera modules are deskewed, devignetted and stitched to form one suite of global images.

19. A portable wide angle video recording and processing system as set forth in claim 1, wherein the allocation of the image sections for stitching is achieved by correct angle alignment with an overlapping section of at least 5°.

20. A portable wide angle video recording and processing system as set forth in claim 1, wherein the alignment of the image sections is achieved by recognition and confocal centering of overlapping picture contents, like differentiable outlines and forms.

21. A portable wide angle video recording and processing system as set forth in claim 20, wherein the allocation of the image sections for stitching and the alignment of the image sections are combined.

22. A portable wide angle video recording and processing system as set forth in claim 18, wherein from these global images an inner frame is selected to build a master image, while extrapolating the movement of the camera set and single anti-shake corrections.

23. A portable wide angle video recording and processing system as set forth in claim 22, wherein the master images comprise horizontal and vertical field viewing angles, that exceed standard video formats, so to allow focussing on or cutting out selected content.

24. A portable video recording and processing system as set forth in claim 1, wherein an extraction of different video formats and screen windows is executed from the composed master images.

25. A portable wide angle video recording and processing system as set forth in claim 1, wherein all self-adjusted parameters of the camera modules are recorded on the memory set or transferred to a control center for to realize adequate transitions in post-processing.
